(19) United States
(12) Patent Application Publication
(10) Pub. No.: US 2006/0052163 A1
(43) Pub. Date: Mar. 9, 2006

(54) Video game machine, video game machine server, and video game machine system

(75) Inventor: Eiji Aida, Tokyo (JP)

Correspondence Address: SHINJYU GLOBAL IP COUNSELORS, LLP, 1233 20TH STREET, NW, SUITE 700, WASHINGTON, DC, 20036-2680, US

(73) Assignee: KONAMI CORPORATION, Tokyo (JP)

(21) Appl. No.: 11/160,417

(22) Filed: Jun. 23, 2005

(30) Foreign Application Priority Data
Sep. 8, 2004 (JP) 2004-260833

(51) Int. Cl. A63F 13/00

(52) U.S. Cl. 463/31

(57) ABSTRACT

A video game machine is disclosed which includes an image display unit for displaying game images, a touch screen for displaying operating elements used to operate the game, an attribute data memory, an attribute data output unit, an attribute assignment unit, and an assignment signal input unit for starting the attribute assignment unit. The attribute assignment unit receives a signal from the assignment signal input unit, reads attribute data for one attribute from the attribute data memory, associates the one attribute to an operating element having one function, and outputs the result as an image to the touch screen.

### BACKGROUND OF THE INVENTION

1. Field of the Invention

The present invention relates to a video game machine, video game machine server, and video game machine system which allow a player to play predetermined games.

2. Background Information

Game machines are known which increase performance results and the like by implementing displays on display units using a communication network.

For example, the game machine disclosed in Japanese Laid-Open Patent Publication No. 2004-24661 displays the content of display data by means of an electroluminescent (EL) display device around the perimeter of a game field, in order to increase an advertising effect or ornamentation effect.

This game machine is, for example, a pachinko game machine or slot machine, which controls the display of the EL display device based on the display data transmitted from a hall computer, and this data is displayed on the EL display device around the perimeter of the game field.

This game machine also allows a player to optionally select a game using a touch screen on a game device which is provided with the previously described display.

The game machine described in U.S. Pat. No. 4,856,787, for example, is a distributed game network which includes a host game device and many slave game devices. The slave game devices allow selection of games such as poker, bingo, blackjack, keno and the like, which may be executed simultaneously. The slave game devices are provided with a touch screen and interface. The touch screen indicates the state of the on-going game being displayed, and receives the input from the player.

Because conventional game machines employ operation panels which are determined by the game, an interface is not provided for individual players. Therefore, there are occasions when the method of operating the machine is difficult to understand due to the unfamiliarity of the player, occasions when the player is dissatisfied because he or she wants to play a game which has a high degree of relative difficulty, and occasions when the interface does not match the level of the player. Furthermore, with games in which a player strives for operational mastery, there may be occasions when the interface is not suitable for the physical constitution of the player.

In the game machine disclosed in U.S. Pat. No. 4,856,787, the display area for displaying operational information, for example, cannot be adequately ensured because the game and the touch panel are both displayed in the same display region.

In view of the above, there exists a need for a video game machine, video game machine server, and video game machine system which overcomes the above mentioned problems in the prior art. More particularly, an object of the present invention is to provide a video game machine, video game machine server, and video game machine system capable of effectively using the display region to provide an operation area which corresponds to the needs of the player. This invention addresses this need in the prior art as well as other needs, which will become apparent to those skilled in the art from this disclosure.

### SUMMARY OF THE INVENTION

According to one aspect of the present invention, a video game machine includes an image display unit which displays game images for a video game; a touch screen which displays a plurality of operating elements which each have a single function and are used by a player to operate the video game, the touch screen arranged to be physically separate from the image display unit; an attribute data memory which stores attribute data for the plurality of operating elements, the attribute data capable of providing each of the plurality of operating elements with a different attribute; an attribute assignment unit which assigns attribute data for one attribute stored in the attribute data memory to each of the plurality of operating elements; an assignment signal input unit which starts the attribute assignment unit; and an attribute data output unit which outputs the assigned attribute data from the attribute data memory to the touch screen. The attribute assignment unit receives a signal from the assignment signal input unit, assigns attribute data for one attribute stored in the attribute data memory to each operating element, and outputs each assigned attribute data as an image to the touch screen.

In this aspect of the present invention, the image display unit for displaying the game image has a physically separate touch screen, and the images displayed on the touch screen can be changed to match the progress of the game. Furthermore, the display area can be used effectively so as to not display operational information on the image display. Because the display area of the touch screen is expanded, operation method guidance can be easily displayed by means of video images and the like, and guidance for players who are unfamiliar with the operations, as well as special operation methods, can be communicated.

Furthermore, by allowing the data to be modified easily, the touch screen display reduces the complex operations of exchanging terminals and parts replacement necessitated when modifying game consoles and the like. Because changes to the operation region can be readily accomplished in accordance with special conditions, such as providing bonus games and the like, playability and usability can be improved even for individual games by changing the system used by a player to operate the game.

Moreover, the touch screen display pattern can be changed to match the preferences of the player. That is, in order to increase the relative difficulty level and amount of movement, the distance between input regions can be increased, and the region for determining input accuracy can be reduced.

According to another aspect of the present invention, the video game machine further includes a receiving unit for receiving attribute data over a network, and outputting the received attribute data to the attribute data memory.

In this aspect of the present invention, much greater efficiency is obtained in a video game machine system which collectively controls a group of terminals of video game machines installed at remote locations and multiple locations. Changes in operating elements which accompany changes in the games can also be accomplished with less time and trouble because only the content stored on the server is changed.

Diverse games which require different operating elements can be readily played in accordance with player preferences by electronically distributing the game data and the operating element data required for the game operation from the server.

According to yet another aspect of the present invention, the touch screen outputs an operating signal when each of the plurality of operating elements is operated by the player; and the image display unit displays an image associated with each operating signal output from the touch screen.

In this aspect of the present invention, it is possible to change the images to match the timing of the progress of a game and visually represent, for example, a state in which input was skillfully performed, and a state in which the next input can be received. For example, it is possible to represent whether or not a signal input by a player has been performed properly.

According to yet another aspect of the present invention, each attribute is one selected from the group consisting of the position, shape, pattern, color, size, appended text characters, and function description of each operating element.

In this aspect of the present invention, it is possible to improve ease of comprehension by representing the operating elements on the touch screen by various shapes which match the content of the game. Furthermore, the display pattern of the touch screen can be changed to match the needs of the game player.

Multiple options are provided, for example, setting the distance between switches to increase the relative difficulty and amount of movement, reducing the size of the switches for input accuracy, guiding inexperienced users, providing designs to match preferences, and reducing the overall area to match the physical constitution of the player. Furthermore, multiple diverse games which have different operating elements can be provided in accordance with the needs of the operators and players.

According to yet another aspect of the present invention, a video game machine server includes a storage unit capable of communicating with at least one video game machine over a network, and a transmitting unit which sends attributes data to a receiving unit of the video game machine. The storage unit stores attribute data for a plurality of operating elements which each have a single function, are displayed on the touch screen of the video game machine, and are used to operate the video game machine. The attribute data is capable of providing each of the plurality of operating elements with a different attribute.

In this aspect of the present invention, much greater efficiency is obtained in a video game machine system which collectively controls a group of video game machines installed at remote locations and multiple locations. Changes in operating elements which accompany changes in the games can also be accomplished with less time and trouble because only the content stored on the server is changed.

Diverse games which require different operating elements can be readily played in accordance with player preferences by electronically distributing the game data and the operating element data required for the game operation from the server.

According to yet another aspect of the present invention, the video game machine system of the present invention includes at least one video game machine and the aforementioned server. The video game machine includes a receiving unit which receives the attribute data from the server over a network; an attribute data memory which stores the attribute data received by the receiving unit; an image display unit which displays game images for a video game; a touch screen which displays a plurality of operating elements which each have a single function and are used by a player to operate the video game, the touch screen arranged to be physically separate from the image display unit; an attribute assignment unit which assigns attribute data for one attribute stored in the attribute data memory to each of the plurality of operating elements; an assignment signal input unit which starts the attribute assignment unit; and an attribute data output unit which outputs the assigned attribute data from the attribute data memory to the touch screen. The attribute assignment unit receives a signal from the assignment signal input unit, assigns attribute data for one attribute stored in the attribute data memory to each operating element, and outputs each assigned attribute data as an image to the touch screen.

In this aspect of the present invention, much greater efficiency is obtained in a video game machine system which collectively controls a group of terminals of video game machines installed at remote locations and multiple locations. Changes in operating elements which accompany changes in the games can also be accomplished with less time and trouble because only the content stored on the server is changed.

Diverse games which require different operating elements can be readily played in accordance with player preferences by electronically distributing the game data and the operating element data required for the game operation from the server.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of the video game machine of the present invention;

FIG. 2 shows the electrical structure of the main parts of the video game machine of the present invention;

FIG. 3 is a flow chart showing the characteristics operations of the video game machine of the present invention;

FIG. 4 is a flow chart showing the characteristics operations of the video game machine of the present invention;

FIG. 5 is an example of a stage (touch screen) display;

FIG. 6 is a conceptual illustration of the video game machine system of the present invention;

FIG. 7 shows the electrical structure of the main parts of the video game machine of the present invention;

FIG. 8 shows the electrical structure of the main parts of the video game machine server of the present invention;

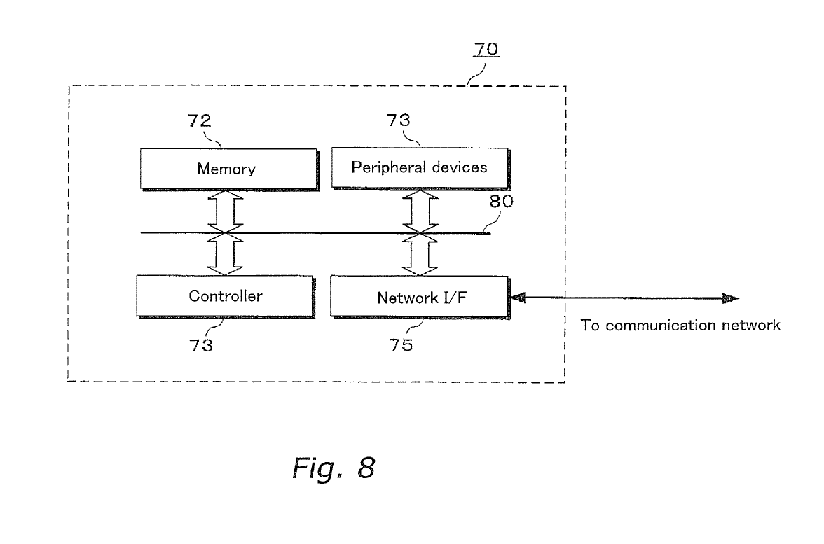

FIG. 9 is a flow chart showing the characteristics operations of the video game machine system of the present invention; and

FIG. 10 is a flow chart showing the characteristics operations of the video game machine system of the present invention.

### DETAILED DESCRIPTION OF THE PREFERRED EMBODIMENTS

The embodiments of the present invention are described hereinafter with reference to the drawings.

The video game machine 1 includes a body 2, and a stage 3 (a touch screen) disposed in front of the body 2. The body 2 includes a game display 4, a setting operation panel 5 provided below the game display 4, and music speakers 6 disposed on both sides of the setting operation panel 5. A coin insertion slot (not shown in the drawing) is provided on the lateral center area of the setting operation panel 5.

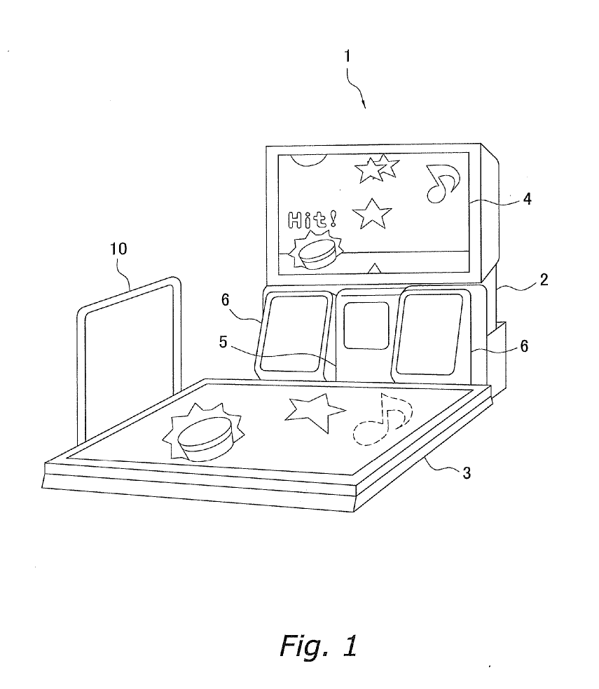

As shown in FIG. 1, the game display 4 is mounted at a position which is readily viewable by a player standing on the stage 3. The game display 4 is physically independent of the system used by a player to operate the game, and only displays images of the game during play. This aspect differs from a card game machine and the like in which the operation panel and the image display unit are unified. For example, in addition to a display of footstep guide marks on the stage 3 which match a song or rhythm, images of dancing characters which match the song or rhythm in the background are displayed on the game display 4. Furthermore, a list of songs is displayed on the game display 4 at the start of the game.

In this way, the stage 3 is physically separate from the game display 4 for displaying game images, and the stage 3 can be changed to match the progress of the game. Furthermore, the game display 4 does not display operation information, and thus can be used efficiently. Because the display area of the stage 3 is expanded, operation method guidance can be easily displayed by means of video images and the like, and guidance for players who are unfamiliar with the operations, as well as special operation methods, can be communicated.

The game display 4 displays images which reflect game operation, based on operating signals input from the stage 3. In this way, it is possible to change the images to match the timing of the progress of a game, and thus visually indicate when a player has skillfully performed game input, when the next input can be received, and the like. For example, it is possible to indicate whether or not a signal input by a player has been performed properly.

The setting operation panel 5, which is provided in the center on the front of the video game machine 1, is provided to allow the player to set the game settings at the start of the game. The setting operation panel 5 includes a joystick, buttons and the like, to make it possible to move a displayed cursor vertically and side-to-side. The setting operation panel 5 may be used, for example, to select a desired song from a list of song titles displayed on the game display 4. A song can be selected by pressing a selection button after the joystick has been moved so as to align the cursor on the desired song displayed.

Furthermore, a player may also select the shape, position, size, and the like of the footstep guide marks on the stage 3 by similarly operating the setting operation panel 5. That is, the setting operation panel 5 operates as an assignment signal input unit, which allows a player to assign one or more of a plurality of attributes to a footstep guide mark, and then outputs the assigned attribute(s) to the footstep guide marks on the stage 3. As noted in greater detail below, attributes include such things as the shape, position, size, and the like of the footstep guide marks.

In this way, the display of the stage 3 reduces complex operations such as exchanging terminals and replacing parts that is necessitated when modifying game consoles and the like, by allowing data to be modified easily. Because changes to the operation region (the stage 3) can be readily accomplished in accordance with special conditions, such as providing bonus games and the like, playability and usability can be improved even for individual games.

Furthermore, the display pattern of the stage 3 can be changed to match the preferences of the player. That is, in order to increase the relative difficulty level and amount of movement, a player can, among other things, increase the distance between input regions, and reduce the size of the regions used to determine input accuracy.

The setting operation panel 5 also may be configured as a touch panel. The functions of the setting operation panel 5 may also be located in the stage 3.

The music speakers 6, which are provided on both sides of the setting operation panel 5, output musical preludes and the music (including instrumental performance, singing voices, rhythm, etc.) selected by the player.

The stage 3 has a flat panel shape of a required size, which uses light-emitting diodes (LED), liquid crystal (LC), or electroluminescence (EL) as an operation display. Sensors capable of detecting a position on a flat surface through contact are provided on the stage 3. For example, the sensors may include panels and cable switches. When the foot of a player steps on a panel and the load is transmitted to at least one of four cable switches (not shown in the drawing) distributed at the four edges of the stage 3, the cable switch is deformed by the load received, such that the presence of the footstep is detected by the change from the OFF to ON state of the cable switch. An acrylic panel or the like may be used as the panel, for example.

The stage 3 acts as a touch screen, and displays operating elements of the game while the game is being played. Operating elements are generally elements which transmit signals when they are operated, and are equivalent to buttons, joystick, tabs, sliders, and the like. Operating elements include the footstep guide marks which are displayed on the stage 3. On the stage 3, footstep guide marks are displayed so as to match a song or rhythm. When a player steps on a footstep guide mark, a sensor detects the contact and a signal is transmitted. The stage 3 outputs the operation signal corresponding to the operation of the operating element to the game display 4.

Sensors capable of infrared and ultrasonic detection may also be used in place of pressure-sensitive sensors which detect contact pressure through the deformation of a cable switch. A reverse U-shaped member standing at the left side facing the game display of the stage 3 is a hand rail 10.

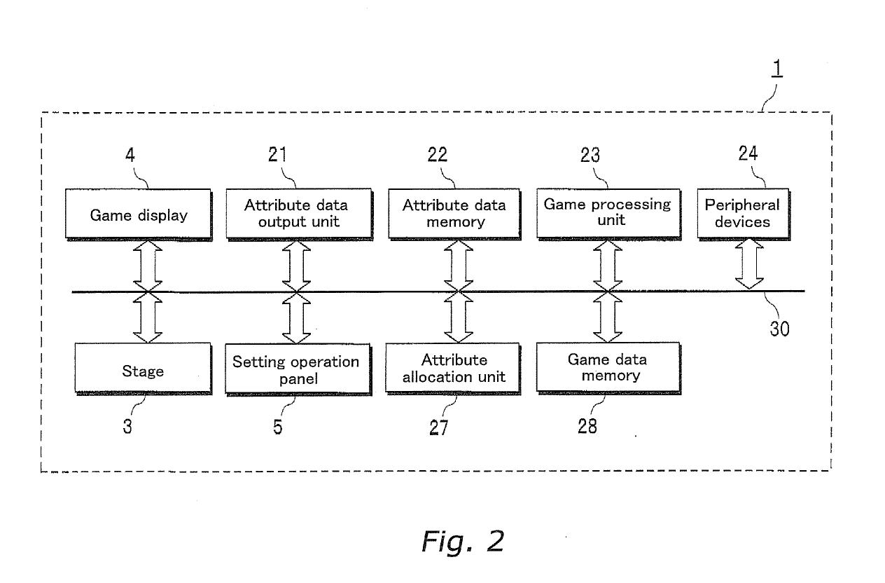

FIG. 2 shows the electrical structure of the main parts of the video game machine 1. As shown in FIG. 2, the video game machine 1 sends and receives signals to and from each part through a data bus 30. A game data memory 28 stores data related to each game which can be selected by a player. For example, in addition to control programs for controlling operations, the game data memory 28 can store music data for each song title, that is, a table which associates song titles with the performance data for each song title, a table which associates footstep guide marks with rhythms in accordance with the degree of difficulty, and a table which associates dance images to be displayed on the game display 4 with each song or rhythm. There are a number of tables which include footstep guide data. In addition to the above, there are also tables which classify footstep guide data by beat count, or which classify footstep guide data by rhythms having the same beat count, e.g., by the music for each song music or each song itself. The game data memory 28 includes at least either RAM or ROM.

The video game machine 1 is specifically provided with an internal or removable cartridge-type ROM which stores game programs, and RAM for temporarily storing processing data. The recording medium for storing game programs may be a CD-ROM, floppy disk, hard disk, or the like.

A game processing unit 23 reads programs and tables from the game data memory 28, and executes games and controls operations. The game processing unit 23 includes a CPU provided within the video game machine 1. The game processing unit 23 receives instruction signals from the setting operation panel 5, and executes a selection process for the corresponding song. The performance data of the song specified by the selection signal received from the setting operation panel 5 is output to the game display 4 and speakers 6 in time series.

An attribute data memory 22 stores attribute data for a plurality of operating elements that are to be displayed as images on the stage 3. Each operating element has a single function that may be different from the functions of the other operating elements, but each operating element can have one or more different attributes. The game data memory 28 includes at least either RAM or ROM. The operating elements function to send specific signals when operated. For example, in this embodiment, the operating elements function to transmit first step (left foot) and second step (right foot) signals. In the example of a slot machine, an operating element may have a betting function or a spin command function. Attributes are, for example, the position, shape, pattern, color, size, color, and appended text characters of the operating elements on the stage 3. With a slot machine, for example, there is a plurality of attribute data for an operating element having a betting function, and a plurality of attribute data for an operating element having a spin command function. The attributes may also include a description of the function of each operating element. Furthermore, it is possible for each operating element to have a different set of attributes, and for each operating element to have at least one attribute that is different from the attributes of the other operating elements.

In this way, it is possible to improve ease of comprehension by representing the operating elements on the stage 3 by various shapes which match the content of the game. Furthermore, the display pattern of the stage 3 can be changed to match the needs of the game player.

Multiple options may be provided, e.g., setting the distance between switches to increase the relative difficulty and amount of movement, reducing the switches for input accuracy, guiding inexperienced users, providing designs to match preferences, and reducing the overall area to match the physical constitution of the player. Furthermore, multiple diverse games which have different operating elements can be provided in accordance with the needs of the operators and players.

An attribute data output unit 21 reads attribute data of the plurality of the operating elements from the attribute data memory 22, and output the data to the stage 3. The attribute data output unit 21 includes a CPU.

Based on the attribute data output to the stage 3 by the attribute data output unit 21, the attribute assignment unit 27 assigns one or more attributes to each operating element and outputs the data to the stage 3. That is, the attribute data assignment unit 27 is started by a signal transmitted from the setting operation panel 5, and the selected position, shape and the like are read from the attribute data memory 22 by the attribute assignment unit 27, which then assigns the data to each operating element on the stage 3. The attribute data assignment unit 27 includes a CPU.

Peripheral devices 24 include currency and card recognition machines, various sensors, amplifiers, and speakers 6.

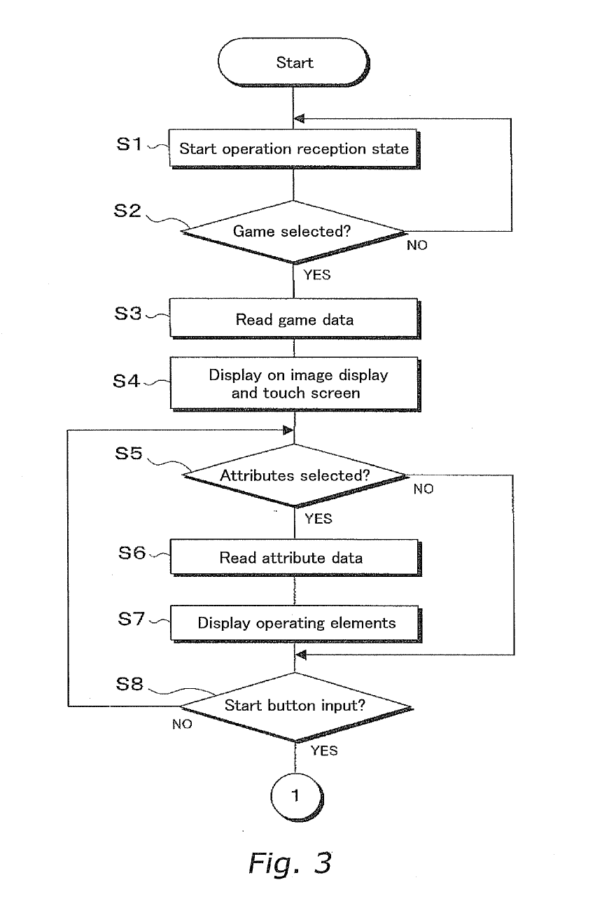

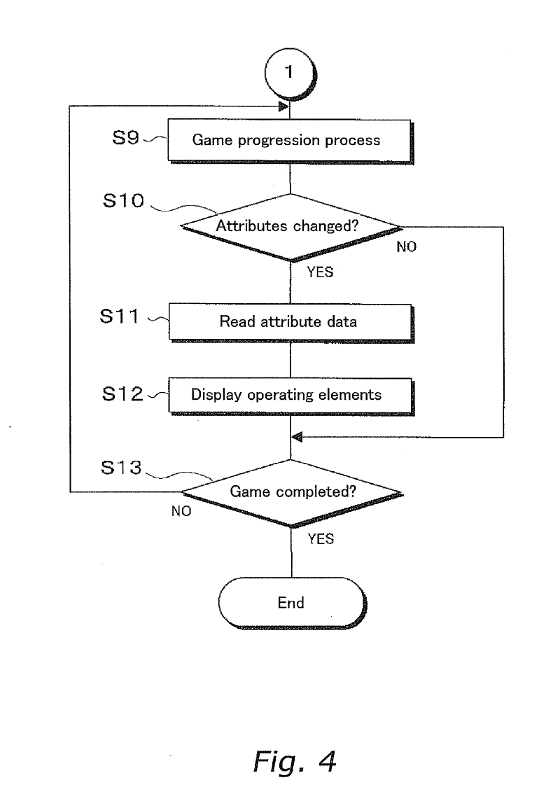

The operation of the video game machine 1 is described below. FIGS. 3 and 4 are flow charts showing the characteristic operation of the video game machine 1.

First, the video game machine 1 is started by inserting a coin or the like, and transitions to the start operation reception state (step S1). In the start operation reception state, player input is received by the setting operation panel 5. For example, a player selects a desired song from a list of song titles displayed on the game display 4, or the selects the position and shape and the like of the footstep guide marks on the stage 3.

Next, a determination is made as to whether or not the game, that is, the song and the relative level of difficulty have been selected (step S2). When a game has not been selected, the routine returns to the start operation reception state. When a game has been selected, data corresponding to the selected game, that is, the song and level of difficulty, are read from the game data memory (step S3). Based on the read data, the game content is displayed on the game display 4, and the footstep guide marks are displayed on the stage 3 (step S4). At this time, the video machine 1 is still in a wait state waiting to start the game.

Next, a determination is made as to whether or not the operating elements, that is, the attributes related to the footstep guide marks, have been selected (step S5). When the attributes have not been selected, the routine moves to step S8. When the attributes have been selected, the attribute data assignment unit 27 reads the selected attribute data from the attribute data memory 22 (step S6). Then, the attribute assignment unit 27 displays the footstep guide marks reflecting the selected attribute data on the stage 3 (touch screen) (step S7).

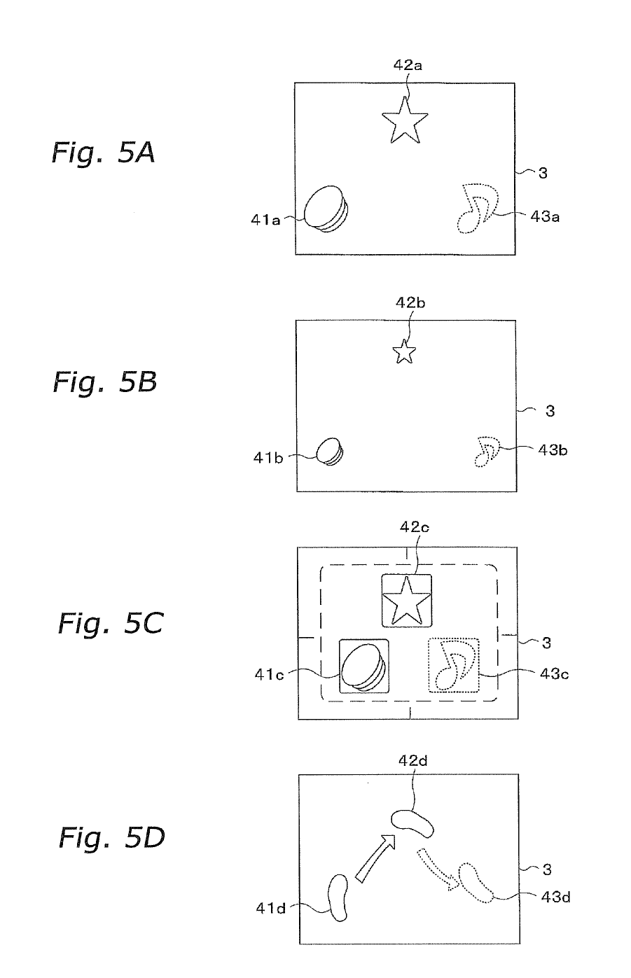

As shown in FIG. 5, for example, the footstep guide marks correspond to the first through third steps in a time series, and these marks are displayed on the stage 3. In the example of the stage 3 display shown in FIG. 5(a), a footstep guide mark 41a corresponding to a first step (left foot) is a drum mark, a footstep guide mark 42a corresponding to a second step (right foot) is a star mark, and a footstep guide mark 43a corresponding to a third step (left foot) is a musical note mark. The third step is displayed in dashed lines. The display example of FIG. 5(a) an example of the default display.

The aforesaid player selections are set to allow the selection of footstep guide mark attributes. For example, FIG. 5(b) is an example of a display when attributes are selected for an experienced player. The footstep guide marks 41b through 43b are displayed farther apart and smaller. Furthermore, FIG. 5(c) is an example of a display when attributes are selected for a beginning player. The footstep guide marks 41c through 43c are closer together and the marks are enclosed in squares for easy comprehension.

Furthermore, the foot-shaped marks 41d through 43d may be displayed as shown in FIG. 5(d) when a player wants guidance on foot placement direction.

Next, a determination is made as to whether or not there is input from the start button (step S8). When there is no input from the start button, the routine returns to step S5. When there is start button input, however, the game progression process is executed by the game processing unit 23. For example, a musical performance is output to the speakers 6, and footstep guide marks corresponding to the selected song are read one data set at a time synchronously with the song progression from the game data memory 28, and displayed on the game display.

Next, a determination is made as to whether or not there is an attribute change in accordance with the progress of the game (step S10). When there is no attribute change, the routine moves to step S13. When there is an attribute change, the attribute assignment unit 27 reads the new attribute data from the attribute data memory 22 (step S11), and transmits an output signal to the attribute data output unit 21. The attribute data output unit 21 displays the footstep guide marks reflecting the new attribute data on the stage 3 (step S12).

Next, a determination is made as to whether the game is completed, for example, whether or not a predetermined time has elapsed since the start of the game, whether or not the instrumental performance of the selected song is completed, or whether or not a predetermined dance evaluation above a certain level has been maintained (step S13). If the game is not completed, the routine returns to step S9. When it is determined that the game has been completed, an evaluation of the player's dancing is displayed on the game display 4, and the game ends.

Unless specifically prohibited, the determinations and processing for controlling the game are performed by the game processing unit 23. Although the video game machine 1 has been described in terms of a dance game machine, the video game machine 1 is not specifically limited to a dance game machine inasmuch as the present invention is applicable to typical video game machines including slot machines, bingo games, fighting games, and the like.

### Second Embodiment

Although the first embodiment has been described in terms of a stand-alone video game machine, the present invention is also applicable to video game machine systems in which a plurality of video game machines are connected to a video game machine server over a communication network.

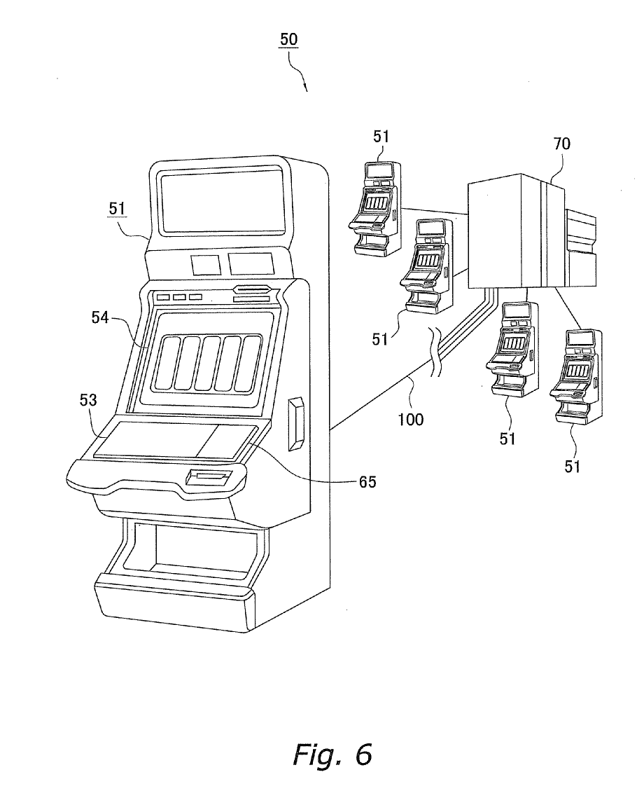

FIG. 6 is a conceptual illustration of a video game machine system 50. As shown in FIG. 6, a video game machine 51 includes a touch screen 53 and setting operation panel 65 which receive input from a player, and a screen display unit 54 for displaying the game. The touch screen 53 and setting operation panel 65 which displays the operation part are displayed independently from the screen display unit 54 which displays the game. The video game machine 51 is connected to a communication network 100, and is capable of transmitting data request signals and receiving data.

A server 70 is similarly connected to the communication network 100 and receives signals from the video game machine 51, processes the signals internally, and transmits the data requested by the video game machine 51 to the video game machine 51. A plurality of video game machines 51 may be connected to the server 70.

The video game machine 51 has player selectable games including a slot machine, bingo game, and card games. The data required for each game are received from the server 70, and the touch screen 53 displays buttons having different attributes which correspond to the selected game.

In this way, much greater efficiency is obtained in a video game machine system 50 which collectively controls a group of video game machines 51 installed at remote locations and multiple locations. Changes in operating elements which accompany changes in the games can also be accomplished with less time and trouble because only the content stored on the server 70 is changed.

Diverse games which require different operating elements can be readily played in accordance with player preferences by electronically distributing the game data and the operating element data required for the game operation.

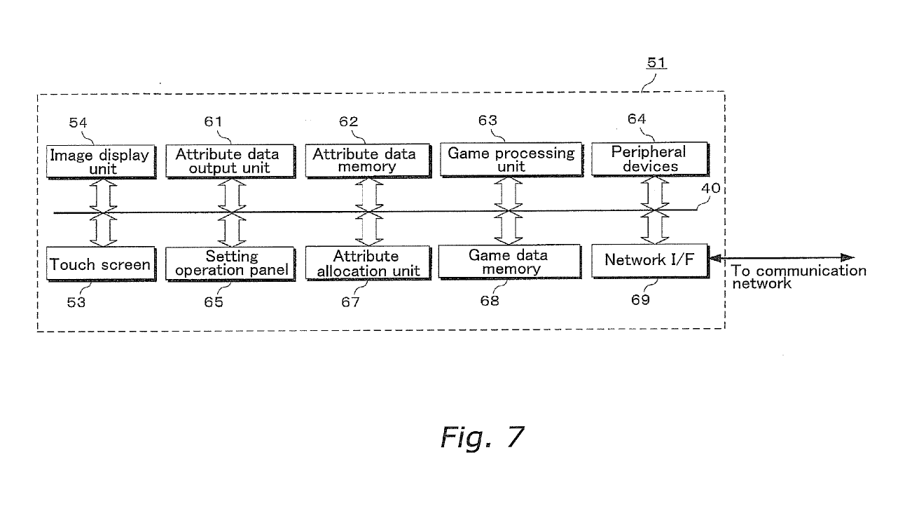

FIG. 7 shows the electrical structure of the main parts of the video game machine 51. As shown in FIG. 7, the video game machine 51 includes a touch screen 53, image display unit 54, attribute data output unit 61, attribute data memory 62, game processing unit 63, peripheral devices 64, setting operation unit 65, attribute assignment unit 67, game data memory 68, network interface 69, and data bus 40. The video game machine 51 sends and receives signals to and from each part through the data bus 40. An assignment signal input unit is included in the setting operation panel 65.

The network interface 69 is connected to the communication network 100, and is used when sending and receiving data. The network interface 69 functions as a receiving unit particularly when receiving game data which include attribute data of the operating elements transmitted from the server 70. The peripheral devices 64 include, for example, currency and card recognition machines, various sensors, amplifiers, speakers and the like.

The game data memory 68 stores data related to each game received from the server 70 by player selection. For example, the game data memory 28 stores data such as control programs for controlling operations, symbol images, symbol layouts and assignment tables and the like. The game data memory 68 includes at least either RAM or ROM. The recording medium for storing game programs may be a CD-ROM, floppy disk, hard disk or the like.

The game processing unit 63 transmits reception request signals of selected game data to the server 70, and receives the game data from the server 70, which are stored in the game data memory 68, and reads the programs and tables from the game data memory 68, and executes the game and controls the operations thereof. The game processing unit 63 includes a CPU provided within the video game machine 51. The game processing unit 63 executes the game selection process and the game progression process. The selection signal is received from the setting operation panel 65 and the specified game data are output to the image display unit 54 or peripheral devices 64 in time series.

The attribute data memory 62 stores the attribute data for a plurality of the operating elements. Each operating element has a single function that may be different from the functions of the other operating elements, but each operating element can have one or more different attributes that are related to the game operation buttons and the like to be displayed as images on the touch screen 53. The attribute data memory 62 includes at least either RAM or ROM. The attribute data may also include a description of the function of each operating element. Furthermore, it is possible for each operating element to have a different set of attributes, and for each operating element to have at least one attribute that is different from the attributes of the other operating elements.

An attribute data output unit 61 reads the attribute data from the attribute data memory 62, and outputs the data to the touch screen 53. The attribute data output unit 61 includes a CPU.

Based on the attribute data output to the image display unit 54 by the attribute data output unit 61, the attribute assignment unit 67 assigns one or more attributes to an operating element, and outputs the attributes to the touch screen 53. That is, the attribute data assignment unit 67 is started by a signal transmitted from the setting operation panel 65, and the selected position, shape, and the like are read from the attribute data memory 62 by the attribute assignment unit 67, which then assigns the data to the game operation buttons displayed on the touch screen 53. The attribute data assignment unit 67 includes a CPU.

The server 70 includes a network interface 75 which is connected to the communication network for sending and receiving signals, peripheral devices 73, memory 72, and controller 74. The peripheral devices 73 include communication devices such as conversion devices, hubs, coding devices and the like. The memory 72 stores game data selectable by a player, and attribute data of operating elements accompanying the game. The memory 72 stores attribute data for a plurality of operating elements.

The controller 74 discriminates the selected game from the game data reception request signal from the video game machine 51, reads the selected game data from the memory 72, and transmits the data to the video game machine 51. At this time, the network interface 75 functions as a transmission unit for transmitting the selected game data to the video game machine 51.

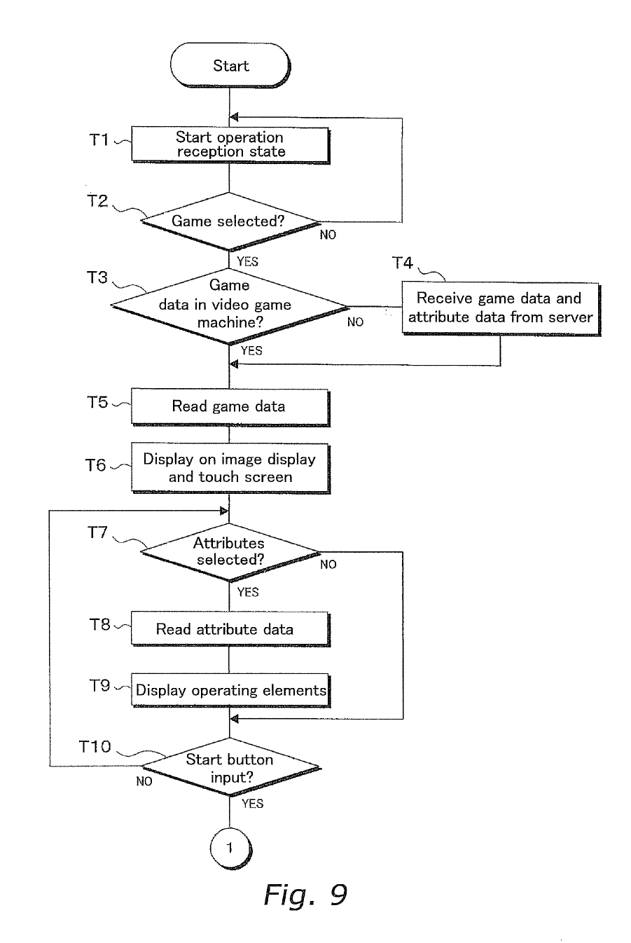

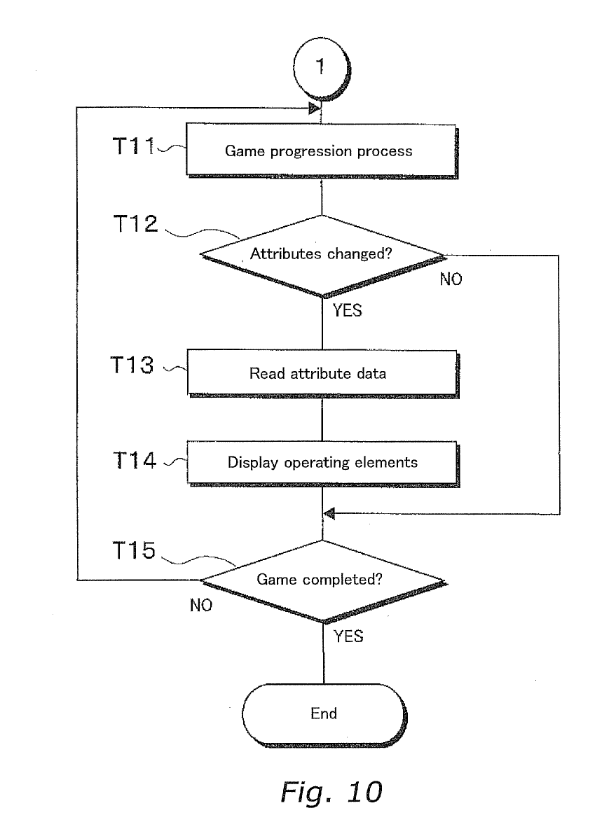

The operation of the video game machine system 50 is described below. FIGS. 9 and 10 are flow charts showing the characteristic operations of the video game machine system 50.

First, the video game machine 1 is started by inserting a coin or the like, and transitions to the start operation reception state (step T1). In the start operation reception state, player input is received by the setting operation panel 65. For example, a player selects a desired game from a list of games displayed on the image display unit 54, or selects the attributes of the operating elements on the touch screen 53.

Next, a determination is made as to whether or not the game has been selected (step T2), and when a game has not been selected, the routine returns to the start operation reception state. When a game has been selected, game processing unit 63 determines whether or not data corresponding to the selected game are stored in the game data memory 68 of the video game machine 51 (step T3).When the game data are not stored in the video game machine 51, the game processing unit 63 transmits a game data reception request signal to the server 70, and the video game machine 51 receives the selected game data from the server 70, and stores the data in the game data memory (step T4). At this time in the server 70, the controller 74 discriminates the selected game data from the game data reception request signal, reads the selected game data from the memory 72, and transmits the game data to the video game machine 51. The data include attribute data of operating elements corresponding to the game.

Next, the game processing unit 63 of the video game machine 51 reads the selected game data from the game data memory 68 (step T5). Based on the read data, the game contents are displayed on the image display 54, and the operating elements are displayed on the touch screen 53 (step T6). At this time, the video machine 51 is still in a wait state waiting to start the game.

Next, in the video game machine 51, a determination is made as to whether or not attributes have been selected for the operating elements (step T7). When the attributes have not been selected, the routine moves to step T10. When attributes have been selected, the attribute assignment unit 67 reads the selected attribute data from the attribute data memory 62 (step T8). Then, the attribute assignment unit 67 displays the operating elements reflecting the selected attribute data on the touch screen 53 (step T9).

Next, in the video game machine 51, a determination is made as to whether or not there has been input from the start button (step T10). When there is no start button input, the routine returns to step T7. When there has been input from the start button, the game progression process is executed by the game processing unit 63. For example, the prize drawing is executed, and the displayed symbols on the reels of the slot machine are changed in the image display unit 54.

Next, a determination is made as to whether or not the attributes have been changed in conjunction with the progress of the game (step T12). When the attributes have not been changed, the routine moves to step T15. When the attributes have been changed, the attribute assignment unit 67 reads the new attribute data from the attribute data memory 62 (step T13), and transmits the output signals to the attribute data output unit 61. The attribute data output unit 61 displays the operating elements reflecting the new attribute data (step T14).

Then, a determination is made as to whether or not the game is completed (step T15). If the game has not been completed, the routine returns to step T11. If it is determined that the game has been completed, the game result is displayed on the image display unit 54, and the game ends.

Unless specifically prohibited, the determinations and processing for controlling the game in the video game machine 51 are performed by the game processing unit 63. Although the video game machine 51 has been described in terms of a slot machine, the video game machine 51 is not specifically limited to a slot machine inasmuch as the present invention is applicable to general video game machines.

Although the attribute data memory 62 and game data memory 68 of the video game machine 51 includes RAM or ROM in the second embodiment, just a graphic controller or the like may be used as the attribute data memory 62 and game data memory 68 without providing an actual memory area. That is, the video game machine 51 may have just a housing, with most of the structure in the server 70, so as to display the required operating elements acquired by normal communication on the touch screen of the game machine.

In this case there is no need to save data in the game machine 51 so that the structure of the video game machine 51 can be simplified and the cost reduced. The video game machine 51 fulfills an intermediary role in this case, and actual control is performed by the server 70. The time and trouble of changing data is reduced because only the server 70 performs the operations.

Furthermore, the attribute data memory 62 and game data memory 68 of the video game machine 51 may also be configured by a temporary memory area such as a buffer. This configuration lies between the second embodiment, and a configuration in which an actual memory area is not provided. Compared to when an actual memory area is not provided, therefore, the control of the video game machine 51 is accomplished with less communication traffic, but greater commitment to the video game machine 51. This arrangement can also easily handle substantial and frequent changes of data.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A video game machine comprising:
an image display unit which displays game images for a video game;
a touch screen which displays a plurality of operating elements which each have a single function and are used by a player to operate the video game, the touch screen arranged to be physically separate from the image display unit;
an attribute data memory which stores attribute data for the plurality of operating elements, the attribute data capable of providing each of the plurality of operating elements with a different attribute;
an attribute assignment unit which assigns attribute data for one attribute stored in the attribute data memory to each of the plurality of operating elements;
an assignment signal input unit which starts the attribute assignment unit; and
an attribute data output unit which outputs the assigned attribute data from the attribute data memory to the touch screen;
wherein the attribute assignment unit receives a signal from the assignment signal input unit, assigns attribute data for one attribute stored in the attribute data memory to each operating element, and outputs each assigned attribute data as an image to the touch screen.

2. The video game machine of claim 1, further comprising:
a receiving unit which receives attribute data over a network, and outputs the received attribute data to the attribute data memory.

3. The video game machine of claim 1, wherein the touch screen outputs an operating signal when each of the plurality of operating elements is operated by the player; and
the image display unit displays an image associated with each operating signal output from the touch screen.

4. The video game machine of claim 1, wherein the attribute is one selected from the group consisting of the position, shape, pattern, color, size, appended text characters, and function description of each operating element.

5. A video game machine server, comprising:
a storage unit capable of communicating with at least one video game machine over a network, the storage unit storing attribute data for a plurality of operating elements which each have a single function, are displayed on a touch screen of the video game machine, and are used to operate the video game machine, the attribute data capable of providing each of the plurality of operating elements with a different attribute; and
a transmitting unit which sends attribute data to a receiving unit of the video game machine.

6. A video game machine system, comprising:
at least one video game machine and the server of claim 5;
the video game machine comprising:
a receiving unit which receives the attribute data from the server over a network;
an attribute data memory which stores the attribute data received by the receiving unit;
an image display unit which displays game images for a video game;
a touch screen which displays a plurality of operating elements which each have a single function and are used by a player to operate the video game, the touch screen arranged to be physically separate from the image display unit;
an attribute assignment unit which assigns attribute data for one attribute stored in the attribute data memory to each of the plurality of operating elements;
an assignment signal input unit which starts the attribute assignment unit; and
an attribute data output unit which outputs the assigned attribute data from the attribute data memory to the touch screen;
wherein the attribute assignment unit receives a signal from the assignment signal input unit, assigns attribute data for one attribute stored in the attribute data memory to each operating element, and outputs each assigned attribute data as an image to the touch screen.
